(19) United States
(12) Patent Application Publication
(10) Pub. No.: US 2021/0164259 A1
(43) Pub. Date: Jun. 3, 2021

(54) ELECTRIC FENCING COMPONENTS

(71) Applicant: Next Generation Polymerics (Pty) Limited, Maitland (ZA)

(72) Inventors: David Johannes PRETORIUS, Pretoria (ZA); Petrus Johannes VERMEULEN, Pretoria (ZA); Wayne George TAYLOR, Pretoria (ZA)

(73) Assignee: Next Generation Polymerics (Pty) Limited, Maitland (ZA)

(21) Appl. No.: 17/045,530

(22) PCT Filed: Apr. 4, 2019
(86) PCT No.: PCT/ZA2019/050018

§ 371 Date: Oct. 6, 2020

(30) Foreign Application Priority Data
Apr. 6, 2018 (ZA) 2018/02244
Oct. 25, 2018 (ZA) 2018/07108

(51) Int. Cl. E04H 17/12; C08L 23/06; C08L 23/12; C08L 67/03

(52) U.S. Cl. CPC E04H 17/12; C08L 23/06; A01K 3/005; C08L 67/03; C08L 23/12

(57) ABSTRACT

The invention provides components for an electric fence. The components are made of a composite material including a derivative or a combination of minerals and a polymeric material.

### TECHNICAL FIELD OF THE INVENTION

This invention relates to components for electric fencing such a posts, brackets and insulators.

### BACKGROUND TO THE INVENTION

Typical electric fencing includes metal posts and brackets and also fittings to mount the electric wiring to the posts and brackets. The mountings are normally plastic to mount the wiring and also to insulate the wiring from the metal posts and brackets. Erecting an electric fence requires a number of time consuming steps such as planting the posts, installing insulated mountings and installing the electric wiring. A number of different insulated mountings are required to install the electric wiring.

It is an object of the invention to provide components for electric fencing which simplifies the erection of an electric fence and which is less time consuming to erect.

### GENERAL DESCRIPTION OF THE INVENTION

The inventor experimented with composite materials for various purposes. The composite materials proved to be durable and it was found that the insulating properties and strength of the composite materials are exceptional.

According to the invention there is provided an electric fence component, made of a composite material including:

a derivative or a combination of minerals; and

a polymeric material.

The electric fence component may be selected from posts or dropper posts or brackets or wire mounting fittings or any other component used to construct or erect an electric fence.

The composite material may include between 50 and 90 mass percent of the mineral derivative in the form of a powder and between 50 and 10 mass percent of a polymeric material.

The polymeric material may preferably be a thermoplastic and can be, but is not limited to, Polyethylene, Polypropylene and Polyethylene terephthalate (PET), preferably high density polyethylene (HDPE).

The mineral derivative dust may be waste powder or dust such as a by-product of the mining or rock crushing industry. The powder may be further milled to the preferred particle size. The mineral may typically aluminium oxide or preferably silica based. The mineral particle size may preferably be in the micron range. The mineral powder may be powder and dust preferably having a particle size in the range of 300 to 600 microns. It appears to the inventors that most typical mining or quarry mineral powders will work irrespective of the source.

Titanium Oxide may be added to the mineral dust to increase the structural strength of the composite material.

The components, which are mostly elongate, may be moulded, extruded or pressure formed, or any other feasible method.

The components may be provided with holes or slits transverse thereto for receiving electric wiring there through. The slits may be angled such that wire can be threaded into a passage through the component, which wire will be captured in the passage or slit when the wire is tensioned. The components such as the bracket may be provided with holes for mounting the bracket to a wall or existing fence post. It will be appreciated that no mountings or fittings are required to install the wire of the electric fence.

The invention extends to an electric fence.

The invention also extends to a composition for the manufacture of components for electric fencing, which composition includes;

between 50 and 90 mass percent of a mineral derivative in the form of a powder; and

between 50 and 10 weight percent of a polymeric material.

The properties of the material are typically:

1) Water absorption test method, ASTM D570, result no absorption.
2) Dimensional/thermal stability test, ASTM D2126, stable no change.
3) Thermal conductivity W/mK acceptable for the use.
4) QUV accelerated weathering test, ASTM G154, 1500 h no change.
5) Impact test 6.21 Joules, shows very good impact resistance.
6) Flexural properties test, ISO 178 300 mm centers 1346N (135 kg).
7) Tensile test 13, 925 MPa.
8) A temperature rise test according to IEC/SANS 60137 was passed.

To illustrate the exceptional insulating properties, a bushing, made of the same material, equivalent to a traditional, 1 kV, 12 mm copper stem bushing was mounted on a test rig as intended for use in practise. The test voltage was slowly increased across the bushing via the copper stem, until the voltage break down to earth. 17 kV was registered and recorded at the point of break down. It was found that leakage occurred through the air gap between the bushing body and the insert, to the metal tank, and not through the insulating material. During the oil submerged test the point of breakdown was up to 31 kV.

The thermoplastic material and mineral dust is inserted into a gravimetric blender of weigh scale blender and the blender then weighs and blends until a homogenous mixture is obtained. Pellets are manufactured, certified and ready for further use in an extrusion, injection or compression moulding machine.

The components have both a structural and an insulating function, which simplifies erection of an electric fence.

Typical electric fence components include but is not limited to posts, horizontal rails, pales, dropper posts, wire fittings and the like.

It is to be appreciated that the components such as posts can also be used for other purposes such as sign posts or non-electrified fences.

### DETAILED DESCRIPTION OF THE INVENTION

The invention is now described by way of non-limiting examples with reference to the accompanying drawings.

In the drawings:

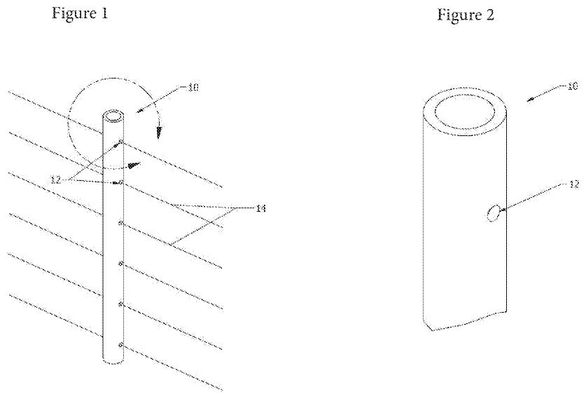

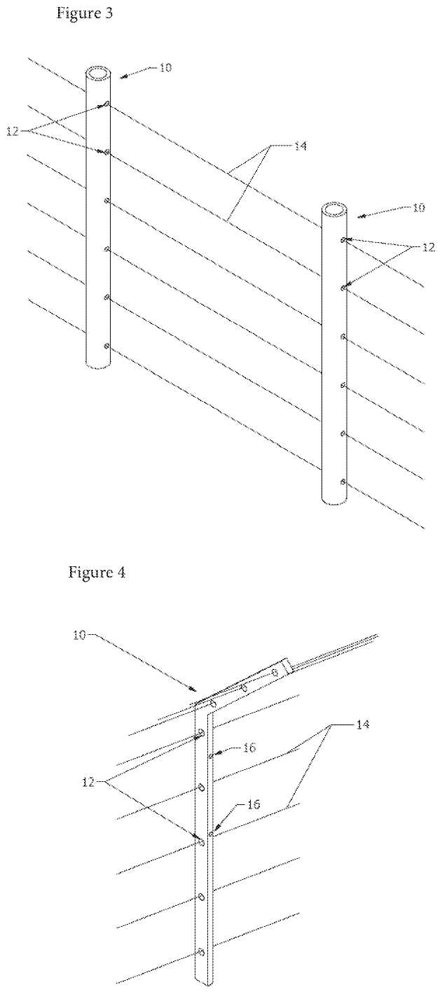

FIGS. 1 and 3 shows an electric fence, in accordance with the invention,

FIG. 2 shows details of a post of the electric fence,

FIG. 4 shows a bracket for an electric fence, in accordance with the invention;

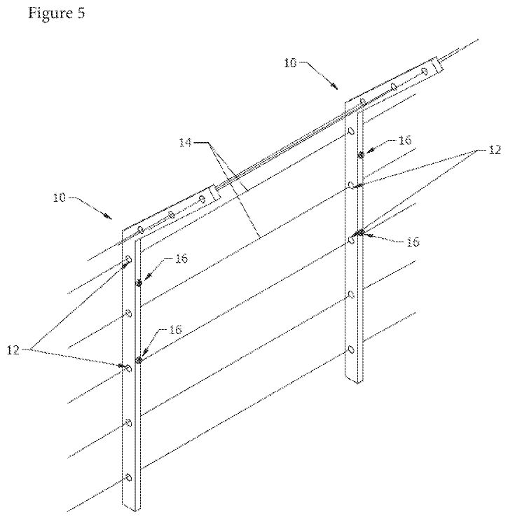

FIG. 5 shows an electric fence erected with the brackets;

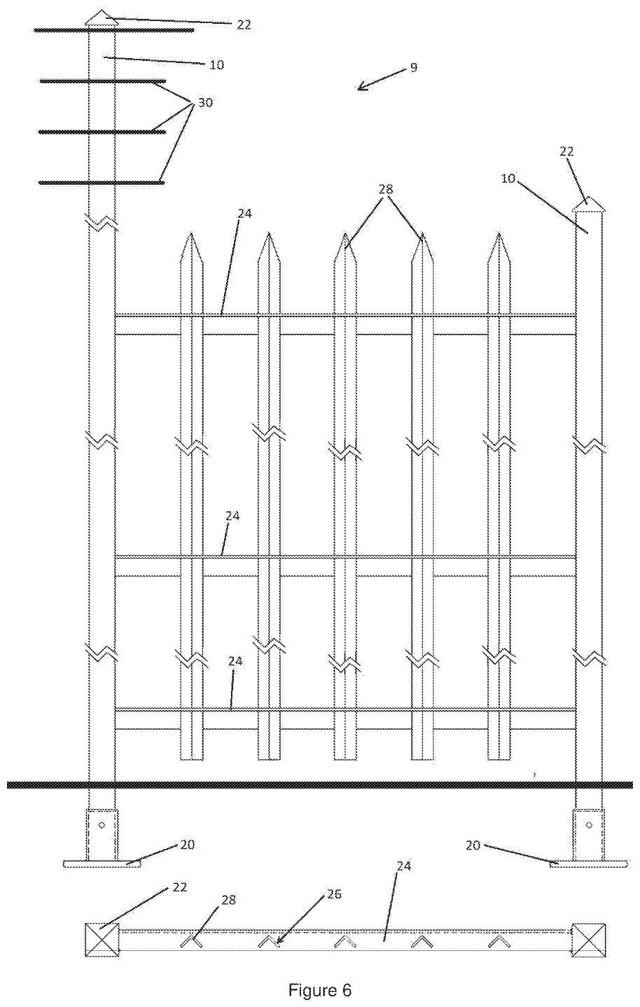

FIG. 6 shows aide and top view of another embodiment of a fence comprising components of an electric fence in accordance with the invention; and

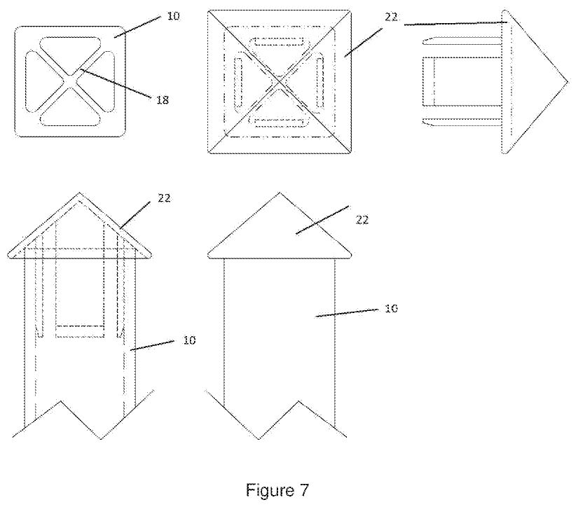

FIG. 7 shows detailed views of some of the components.

Referring now to the drawings, the component, generally indicated with reference numeral 10, shown in the FIGS. 1 to 3 is a post for an electric fence and the component shown in FIGS. 4 and 5 is a bracket for an electric fence, which can be mounted to an existing post for a fence or a wall.

A first set of components is extruded or moulded from pellets of a composite material, which includes 40 mass percent of thermoplastic HDPE polymeric material and 60 mass percent of a silica based mineral powder having an average particle size of 450 micron. In this case, the mineral powder was sourced from a stone quarry in the Free State South Africa known as Bultfontein. Analysis of the screened mineral powder showed the major components to be 91 mass percent silica and 4.4% Aluminium oxide with the rest made up of trace minerals. During mixing of the above two components, 1% UV stabilising agent, 2% colour agent and % flow improving agent is added. These additives are commercially available under different names in powder form.

A second set of components is extruded or moulded from pellets of a composite material, which includes 40 mass percent of thermoplastic HDPE polymeric material and 60 mass percent of a silica based mineral powder having an average particle size of 450 micron. In this case, the mineral powder was sourced from a stone quarry in close to the town of Bronkhorstspruit in South Africa known as Bronx. Analysis of the mineral powder showed the major components to be 87 mass percent silica, 6% aluminium oxide and 2.6% iron oxide with the rest made up of trace minerals. During mixing of the above two components, 1% UV stabilising agent, 2% colour agent and % flow improving agent is added. These additives are commercially available under different names in powder form.

A third set of components is extruded or moulded from pellets of a composite material, which includes 40 mass percent of thermoplastic polypropylene and 60 mass percent of a silica based mineral powder having an average particle size of 450 micron. In this case, the mineral powder was sourced from a stone quarry in the Free State South Africa known as Bultfontein. Analysis of the mineral powder showed the major components to be 91 mass percent silica and 4.4% Aluminium oxide with the rest made up of trace minerals. During mixing of the above two components, 1% UV stabilising agent, 2% colour agent and % flow improving agent is added. These additives are commercially available under different names in powder form.

A fourth set of components is extruded or moulded from pellets of a composite material, which includes 40 mass percent of thermoplastic polypropylene and 60 mass percent of a silica based mineral powder having an average particle size of 450 micron. In this case, the mineral powder was sourced from a stone quarry in close to the town of Bronkhorstspruit in South Africa known as Bronx. Analysis of the mineral powder showed the major components to be 87 mass percent silica, 6% aluminium oxide and 2.6% iron oxide with the rest made up of trace minerals. During mixing of the above two components, 1% UV stabilising agent, 2% colour agent and % flow improving agent is added. These additives are commercially available under different names in powder form.

A fifth set of components is extruded or moulded from pellets of a composite material, which includes 40 mass percent of PET and 60 mass percent of a silica based mineral powder having an average particle size of 450 micron. In this case, the mineral powder was sourced from a stone quarry in the Free State South Africa known as Bultfontein. Analysis of the mineral powder showed the major components to be 91 mass percent silica and 4.4% Aluminium oxide with the rest made up of trace minerals. During mixing of the above two components, 1% UV stabilising agent, 2% colour agent and % flow improving agent is added. These additives are commercially available under different names in powder form.

A sixth set of components is extruded or moulded from pellets of a composite material, which includes 40 mass percent of PET and 60 mass percent of a silica based mineral powder having an average particle size of 450 micron. In this case, the mineral powder was sourced from a stone quarry in close to the town of Bronkhorstspruit in South Africa known as Bronx. Analysis of the mineral powder showed the major components to be 87 mass percent silica, 6% aluminium oxide and 2.6% iron oxide with the rest made up of trace minerals. During mixing of the above two components, 1% UV stabilising agent, 2% colour agent and % flow improving agent is added. These additives are commercially available under different names in powder form.

In a first example, the post and bracket is provided with holes 12 for receiving electric wiring 14 there through. The bracket is further provided with holes 16 for mounting the bracket to a wall or existing fence post.

In another example as shown in FIGS. 6 to 11 a fence 9 is provided, which includes a palisade fence combined with an electric fence. The extruded posts 10 are extruded from pellets of the described composite material in sizes, 50 mm×50 mm, 75 mm×75 mm and 100 mm×100 mm. The posts are extruded with internal strengthening cross members 18 X-shaped in cross section. Bottom 20 and top 22 caps are provided for the posts. The fence further includes extruded angled horizontal rails 24 provided with slots 26 for receiving pales 28 of angled sections there through. The left post 10 as shown in FIG. 6 is elongated and provided holes for receiving electric fencing 30 there through. It is to be appreciated that the composition of the components for the fence gives it good structural strength, durability and insulating properties so that no special connectors and brackets are required as would be required for a typical metal fence. This leads to a material cost and installation time saving.

The composite material can also be used to manufacture other posts such as sign posts and dropper posts such as y-posts.

It shall be understood that the examples are provided for illustrating the invention further and to assist a person skilled in the art with understanding the invention and are not meant to be construed as unduly limiting the reasonable scope of the invention.

1-11. (canceled)

12. An electric fence component, made of a composite material including:
a derivative or a combination of minerals of which the major mineral component is aluminium oxide or silica; and
a thermoplastic polymeric material.

13. The electric fence component as claimed in claim 12, wherein the component is selected from any one of: a post, a dropper post, a bracket and a wire mounting fitting.

14. The electric fence component as claimed in claim 12, wherein the composite material includes between 50 and 90 mass percent of the mineral derivative in the form of a powder and between 50 and 10 mass percent of a polymeric material.

15. The electric fence component as claimed in claim 14, wherein the thermoplastic polymeric material is selected from any one of Polyethylene, Polypropylene and Polyethylene terephthalate (PET).

16. The electric fence component as claimed in claim 12, wherein the mineral has a particle size in the micron range.

17. The electric fence component as claimed in claim 12, wherein the mineral has an average particle size in the range of 300 to 600 microns.

18. The electric fence component as claimed in claim 12, wherein the mineral Titanium Oxide is added.

19. An electric fence, which includes an electric fence component as claimed in claim 12.

20. A composition for the manufacture of components for electric fencing, which composition includes;
between 50 and 90 mass percent of a mineral derivative in the form of a powder of which the major mineral component is aluminium oxide or silica; and
between 50 and 10 weight percent of a thermoplastic polymeric material.
